(19) United States
(12) Patent Application Publication
(10) Pub. No.: US 2025/0323699 A1
(43) Pub. Date: Oct. 16, 2025

(54) MULTIPLE MODE ORBITAL ANGULAR MOMENTUM

(71) Applicant: LENOVO (SINGAPORE) PTE. LTD., Singapore (SG)

(72) Inventors: Sher Ali Cheema, Ilmenau (DE); Seyedomid Taghizadeh Motlagh, Oberursel (DE); Ali Ramadan Ali, Kraiburg (DE)

(73) Assignee: Lenovo (Singapore) Pte. Limited, Singapore (SG)

(21) Appl. No.: 18/865,230

(22) PCT Filed: May 9, 2023
(86) PCT No.: PCT/IB2023/054806

§ 371 Date: Nov. 12, 2024

Related U.S. Application Data
(60) Provisional application No. 63/341,573, filed on May 13, 2022.

(51) Int. Cl. H04B 7/06; H04L 5/00; H04W 76/20

(52) U.S. Cl. CPC H04B 7/0626; H04B 7/0617; H04L 5/0051; H04W 76/20

(57) ABSTRACT

Various aspects of the present disclosure relate to multiple mode orbital angular momentum (OAM). For instance, an association of reference signals (RS) used for information about channel properties (e.g., channel state information references signal (CSI-RS)) to one or multiple OAM modes is provided for performing OAM measurements at a UE. Further, feedback mechanisms are provided for indicating OAM modes based on channel measurements.

### RELATED APPLICATION

This application claims priority to U.S. Patent Application Ser. No. 63/341,573 filed 13 May 2022 entitled “MULTIPLE MODE ORBITAL ANGULAR MOMENTUM,” the disclosure of which is incorporated by reference herein in its entirety.

### TECHNICAL FIELD

The present disclosure relates to wireless communications, and more specifically to transmission and reception modes in wireless communications.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system, such as time resources (e.g., symbols, slots, subslots, mini-slots, aggregated slots, subframes, frames, or the like) or frequency resources (e.g., subcarriers, carriers). Additionally, the wireless communications system may support wireless communications across various radio access technologies (RATs) including third generation (3G) RAT, fourth generation (4G) RAT, fifth generation (5G) RAT, and other suitable RATs beyond 5G. In some cases, a wireless communications system may be a non-terrestrial network (NTN), which may support various communication devices for wireless communications in the NTN. For example, an NTN may include network entities onboard non-terrestrial vehicles such as satellites, unmanned aerial vehicles (UAV), and high-altitude platforms systems (HAPS), as well as network entities on the ground, such as gateway entities capable of transmitting and receiving over long distances.

In wireless communications, different resource domains are available for transmitting and receiving wireless signal. For instance, resources in the time domain and frequency domain can be utilized by UEs and network devices for wireless transmission and reception.

### SUMMARY

The present disclosure relates to methods, apparatuses, and systems that support multiple mode orbital angular momentum (OAM). By utilizing the described techniques, UEs and other wireless devices can utilize OAM for wireless transmission and reception. For instance, an association of reference signals (RS) used for information about channel properties (e.g., channel state information references signal (CSI-RS)) to one or multiple OAM modes is provided for performing OAM measurements at a UE. Further, feedback mechanisms are provided for indicating OAM modes based on channel measurements. For instance, enhancements to reporting configurations to indicate OAM mode-based measurements are proposed. Thus, the present disclosure enables OAM modes to be utilized for wireless communications, which can increase a number of available communication channels in wireless communications systems.

Some implementations of the method and apparatuses described herein may include wireless communication at an apparatus (e.g., a UE), and the apparatus receives, from a network device, configuration information for CSI-RS indicating OAM mode resources; and transmits, to the network device, wireless signal using a subset of the OAM mode resources and based at least in part on OAM mode-based measurements for the subset of the OAM mode resources.

In some implementations of the method and apparatuses described herein, the configuration information for the CSI-RS further includes at least one of a time resource, a frequency resource, a time-domain behavior, an OAM mode index, a usage type corresponding to an RS transmission, an RS reception, or combinations thereof; the configuration information for the CSI-RS is configured such that at least some of the RS correspond to an OAM mode index; the configuration information for the CSI-RS is configured such that at least some of the RS correspond to a different type of sequence generation method for each of the OAM mode resources; the configuration information for the CSI-RS is configured such that at least some of the RS are initialized with OAM mode-specific index information for different OAM modes; the configuration information for the CSI-RS is configured such that code division multiplexing (CDM) between different per-antenna port CSI-RS is extended in an OAM mode domain; the configuration information for the CSI-RS is configured such that an OAM mode number index is configured through radio resource control (RRC) signaling using a bit table.

In some implementations of the method and apparatuses described herein, the configuration information for the CSI-RS is configured such that different antenna ports are associated with different OAM modes; the configuration information for the CSI-RS is configured to include CSI resource identifiers, and each CSI resource identifier is associated with at least one OAM mode; the configuration information for the CSI-RS is configured such that CSI configurations with OAM modes are one or more of aperiodic, periodic, or semi-persistent; the apparatus receives, from the network device, a report configuration for the OAM mode resources; and transmits, based at least in part on the report configuration, a report to the network device including OAM mode-based measurements for one or more RS of the OAM mode resources; a report for each RS of a plurality of RS indicates at least an OAM mode based on OAM mode-based channel measurements; the apparatus transmits multiple reports, and each report is specific to an individual OAM mode.

Some implementations of the method and apparatuses described herein may include wireless communication at an apparatus (e.g., a UE), and the apparatus receives, from a network device, configuration information for CSI-RS indicating at least one OAM mode resource; receives, from the network device, a report configuration for the at least one OAM mode resource; and transmits, based at least in part on the report configuration, a report to the network device including OAM mode-based measurements for one or more references signals of the OAM mode resource.

In some implementations of the method and apparatuses described herein, the report configuration is received as part of RRC signaling; the report includes multiple fields for multiple different OAM modes, and each field includes an OAM mode-based measurement for a respective OAM mode; the multiple fields are arranged in the report based at least in part on channel conditions for the different OAM modes; the apparatus transmits multiple reports, and each report is specific to an individual OAM mode; the OAM mode-based measurements include one or more of channel quality indicator (CQI), precoding matrix indicator (PI), or rank indicator (RI) for the OAM mode resource; the apparatus transmits the report to include channel properties for multiple OAM modes if the multiple OAM modes are orthogonal in an OAM mode domain; and transmits multiple reports to include channel properties for the multiple OAM modes if CSI resources for the multiple OAM modes utilize different respective time resources; the report includes OAM mode-based measurements for one or more non-zero OAM modes detected at the apparatus and based on the report configuration; the apparatus transmits OAM information to the network device identifying one or more OAM modes supported by the apparatus; the OAM information includes one or more of a supported OAM mode for transmission by the apparatus, a supported OAM mode for reception by the apparatus, a preferred OAM mode for transmission by the apparatus, or a preferred OAM mode for reception by the apparatus; the apparatus measures OAM mode dispersion detected at the apparatus, and includes an indication of the OAM mode dispersion in the report.

Some implementations of the method and apparatuses described herein may include wireless communication at an apparatus (e.g., a base station and/or other network device), and the apparatus transmits, to a UE, configuration information for CSI-RS indicating at least one OAM mode resource; transmits, to the UE, a report configuration for the at least one OAM mode resource; and receives, based at least in part on the report configuration, a report from the UE including OAM mode-based measurements for one or more RS of the OAM mode resource.

In some implementations of the method and apparatuses described herein, the configuration information for the CSI-RS further includes at least one of a time resource, a frequency resource, a time-domain behavior, an OAM mode index, a usage type corresponding to an RS transmission, an RS reception, or combinations thereof; the configuration information for the CSI-RS is configured such that at least some of the RS correspond to an OAM mode index; the configuration information for the CSI-RS is configured such that at least some of the RS correspond to a different type of sequence generation method for different OAM mode resources; the configuration information for the CSI-RS is configured such that at least some of the RS are initialized with OAM mode-specific index information for different OAM modes; the configuration information for the CSI-RS is configured such that CDM between different per-antenna port CSI-RS is extended in an OAM mode domain.

In some implementations of the method and apparatuses described herein, the configuration information for the CSI-RS is configured such that an OAM mode number index is configured through RRC signaling using a bit table; the configuration information for the CSI-RS is configured such that different antenna ports are associated with different OAM modes; the configuration information for the CSI-RS is configured such that each CSI resource identifier is associated with at least one OAM mode; the configuration information for the CSI-RS is configured such that CSI configurations with OAM modes are one or more of aperiodic, periodic, or semi-persistent; the apparatus transmits the report configuration as part of RRC signaling; the apparatus receives OAM information from the UE identifying one or more OAM modes supported by the UE, and utilizes at least one supported OAM mode for transmission to the UE.

### BRIEF DESCRIPTION OF THE DRAWINGS

Various aspects of the present disclosure for multiple mode OAM are described with reference to the following Figures. The same numbers may be used throughout to reference like features and components shown in the Figures.

FIG. 1 illustrates an example of a wireless communications system that supports multiple mode OAM in accordance with aspects of the present disclosure.

FIG. 2 depicts OAM modes including five different OAM modes of an OAM wave.

FIG. 3 illustrates example beam generation for OAM modes.

FIG. 4 illustrates an example block diagram of components of a device (e.g., a UE) that supports multiple mode OAM in accordance with aspects of the present disclosure.

FIG. 5 illustrates an example block diagram of components of a device (e.g., a base station, location server, and/or other network device) that supports multiple mode OAM in accordance with aspects of the present disclosure.

FIGS. 6-10 illustrate flowcharts of methods that support multiple mode OAM in accordance with aspects of the present disclosure.

### DETAILED DESCRIPTION

Implementations of multiple mode OAM are described, such as related to methods, apparatuses, and systems that support multiple mode OAM. The present disclosure, for instance, enables OAM modes to be utilized for wireless communications, which can increase a number of available communication channels in wireless communications systems.

In some wireless communications systems, different wireless resources are utilized for wireless communications, such as frequency domain resources (e.g., carriers, subcarriers, etc.) and time domain resources, e.g., symbols, slots, subslots, mini-slots, aggregated slots, subframes, frames, and so forth. However, current wireless communications systems do not provide for resources in some other resource domains, such as in an OAM domain. Thus, such systems are unable to leverage resources in such resource domains for wireless communications.

Accordingly, implementations for multiple mode OAM provide a framework for enabling different OAM modes to be used for wireless communications. For instance, OAM modes with different values of topological charge of a wave are mutually orthogonal, therefore, vortex beams carrying different OAM modes can provide independent communication channels for UEs and other wireless devices for wireless transmission and reception. For example, an association of RS used for information about channel properties (e.g., CSI-RS) to one or multiple OAM modes is provided for performing OAM measurements at a UE. Further, feedback mechanisms are provided for indicating OAM modes based on channel measurements. For instance, enhancements to reporting configurations to indicate the OAM mode-based measurements are proposed. Thus, the present disclosure enables OAM modes to be utilized for wireless communications, which can increase a number of available communication channels in wireless communications systems.

Aspects of the present disclosure are described in the context of a wireless communications system. Aspects of the present disclosure are further illustrated and described with reference to device diagrams and flowcharts that relate to multiple mode OAM.

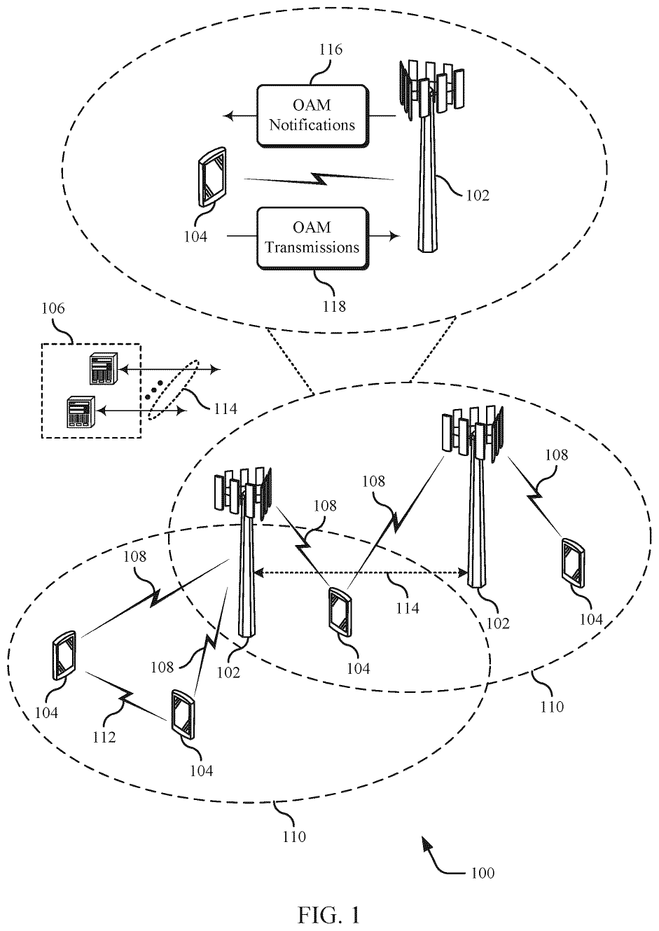

FIG. 1 illustrates an example of a wireless communications system 100 that supports multiple mode OAM in accordance with aspects of the present disclosure. The wireless communications system 100 may include one or more base stations 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be, or include, or may be referred to as a base transceiver station, an access point, a NodeB, an eNodeB (eNB), a next-generation NodeB (gNB), a Radio Head (RH), a relay node, an integrated access and backhaul (IAB) node, or other suitable terminology. A base station 102 and a UE 104 may communicate via a communication link 108, which may be a wireless or wired connection. For example, a base station 102 and a UE 104 may perform wireless communication over a NR-Uu interface.

A base station 102 may provide a geographic coverage area 110 for which the base station 102 may support services (e.g., voice, video, packet data, messaging, broadcast, etc.) for one or more UEs 104 within the geographic coverage area. For example, a base station 102 and a UE 104 may support wireless communication of signals related to services (e.g., voice, video, packet data, messaging, broadcast, etc.) according to one or multiple radio access technologies. In some implementations, a base station 102 may be moveable, such as when implemented as a gNB onboard a satellite or other non-terrestrial station (NTS) associated with a non-terrestrial network (NTN). In some implementations, different geographic coverage areas 110 associated with the same or different radio access technologies may overlap, and different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region or coverage area 110 of the wireless communications system 100. A UE 104 may include or may be referred to as a mobile device, a wireless device, a remote device, a handheld device, a customer premise equipment (CPE), a subscriber device, or as some other suitable terminology. In some implementations, the UE 104 may be referred to as a unit, a station, a terminal, or a client, among other examples. Additionally, or alternatively, a UE 104 may be referred to as an Internet-of-Things (IoT) device, an Internet-of-Everything (IoE) device, or as a machine-type communication (MTC) device, among other examples. In some implementations, a UE 104 may be stationary in the wireless communications system 100. In other implementations, a UE 104 may be mobile in the wireless communications system 100, such as an earth station in motion (ESIM).

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, a gateway device, an integrated access and backhaul (IAB) node, a location server that implements the location management function (LMF), or other network equipment). Additionally, or alternatively, a UE 104 may support communication with other base stations 102 or UEs 104, which may act as relays in the wireless communications system 100.

A UE 104 may also support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, or other network interface). The base stations 102 may communicate with each other over the backhaul links 114 (e.g., via an X2, Xn, or another network interface). In some implementations, the base stations 102 may communicate with each other directly (e.g., between the base stations 102). In some other implementations, the base stations 102 may communicate with each other indirectly (e.g., via the core network 106). In some implementations, one or more base stations 102 may include subcomponents, such as an access network entity, which may be an example of an access node controller (ANC). The ANC may communicate with the one or more UEs 104 through one or more other access network transmission entities, which may be referred to as remote radio heads, smart radio heads, gateways, transmission-reception points (TRPs), and other network nodes and/or entities.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)), and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

According to implementations, one or more of the UEs 104 and base stations 102 are operable to implement various aspects of multiple mode OAM, as described herein. For instance, a base station 102 can transmit OAM notifications 116 to a UE 104. The OAM notifications 116 can include various types of information, such as information identifying OAM resources that can be used by the UE 104 for wireless transmission by the UE 104. The OAM notifications 116 may also include report configuration information for generating OAM information based on OAM resources. In at least one implementation the OAM notifications 116 can be transmitted via CSI-RS. Further, the OAM notifications 116 may accompany other types of information, such as time resources, frequency resources, and/or code domain resources for use by the UE 104. Based at least in part on the OAM notifications 116, the UE 104 transmits OAM transmissions 118 to the base station 102. The OAM transmissions 118 can include various types of information, such as reports that include OAM mode-based measurements for one or more references signals for one or more OAM mode resources, data traffic (e.g., uplink signal) transmitted using OAM mode resources, and so forth. Thus, according to implementations, base stations 102 and UEs 104 are operable to configure UEs 104 to use different OAM modes for wireless transmission and reception.

In wireless communications systems, specifications are provided for UE procedures for reporting channel state information (CSI). For instance, in technical specification (TS) 38.214 a CSI framework is provided. In the framework procedures on aperiodic CSI reporting described in this clause assume that the CSI reporting is triggered by downlink control information (DCI) format 0_1, but they equally apply to CSI reporting triggered by DCI format 0_2, by applying the higher layer parameter reportTriggerSizeDCI-0-2 instead of reportTriggerSize. The time and frequency resources that can be used by the UE to report CSI can be controlled by the gNB. CSI may consist of CQI, PMI, CSI-RS resource indicator (CRI), synchronization signal physical broadcast channel (SS/PBCH) Block Resource indicator (SSBRI), layer indicator (LI), RI, L1-reference signal received power (RSRP) or L1-signal-to-noise and interference ratio (SINR).

For CQI, PMI, CRI, SSBRI, LI, RI, L1-RSRP, LI-SINR a UE is configured by higher layers with N≥1 CSI-ReportConfig Reporting Settings, M≥1 CSI-ResourceConfig Resource Settings, and one or two list(s) of trigger states (given by the higher layer parameters CSI-AperiodicTriggerStateList and CSI-SemiPersistentOnPUSCH-TriggerStateList). Each trigger state in CSI-AperiodicTriggerStateList contains a list of associated CSI-ReportConfigs indicating the Resource Set IDs for channel and optionally for interference. Each trigger state in CSI-SemiPersistentOnPUSCH-TriggerStateList contains one associated CSI-ReportConfig.

Each Reporting Setting CSI-ReportConfig is associated with a single downlink bandwidth part (BWP) (indicated by higher layer parameter BWP-Id) given in the associated CSI-ResourceConfig for channel measurement and contains the parameter(s) for one CSI reporting band: codebook configuration including codebook subset restriction, time-domain behavior, frequency granularity for CQI and PMI, measurement restriction configurations, and the CSI-related quantities to be reported by the UE such as the layer indicator (LI), L1-RSRP, L1-SINR, CRI, and SSBRI (SSB Resource Indicator).

The time domain behavior of the CSI-ReportConfig is indicated by the higher layer parameter reportConfigType and can be set to ‘aperiodic’, ‘semiPersistentOnPUCCH’, ‘semiPersistentOnPUSCH’, or ‘periodic’. For ‘periodic’ and ‘semiPersistentOnPUCCH’/‘semiPersistentOnPUSCH’ CSI reporting, the configured periodicity and slot offset applies in the numerology of the uplink BWP in which the CSI report is configured to be transmitted on. The higher layer parameter reportQuantity indicates the CSI-related, L1-RSRP-related or L1-SINR-related quantities to report. The reportFreqConfiguration indicates the reporting granularity in the frequency domain, including the CSI reporting band and if PMI/CQI reporting is wideband or sub-band. The timeRestrictionForChannelMeasurements parameter in CSI-ReportConfig can be configured to enable time domain restriction for channel measurements and timeRestrictionForInterferenceMeasurements can be configured to enable time domain restriction for interference measurements. The CSI-ReportConfig can also contain CodebookConfig, which contains configuration parameters for Type-I, Type II or Enhanced Type II CSI including codebook subset restriction, and configurations of group-based reporting.

Each CSI Resource Setting CSI-ResourceConfig contains a configuration of a list of S≥1 CSI Resource Sets (given by higher layer parameter csi-RS-ResourceSetList), where the list is comprised of references to either or both of non-zero power (NZP) CSI-RS resource set(s) and SS/PBCH block set(s) or the list is comprised of references to CSI interference measurement (CSI-IM) resource set(s). Each CSI Resource Setting is located in the downlink (DL) BWP identified by the higher layer parameter BWP-id, and all CSI Resource Settings linked to a CSI Report Setting have the same DL BWP.

The time domain behavior of the CSI-RS resources within a CSI Resource Setting can be indicated by the higher layer parameter resourceType and can be set to aperiodic, periodic, or semi-persistent. For periodic and semi-persistent CSI Resource Settings, when the UE is configured with groupBasedBeamReporting-r17, the number of CSI Resource Sets configured is S=2, otherwise the number of CSI-RS Resource Sets configured is limited to S=1. For periodic and semi-persistent CSI Resource Settings, the configured periodicity and slot offset is given in the numerology of its associated DL BWP, as given by BWP-id. When a UE is configured with multiple CSI-ResourceConfigs consisting of the same NZP CSI-RS resource ID, the same time domain behavior shall be configured for the CSI-ResourceConfigs. When a UE is configured with multiple CSI-ResourceConfigs consisting of the same CSI-IM resource ID, the same time-domain behavior shall be configured for the CSI-ResourceConfigs. All CSI Resource Settings linked to a CSI Report Setting shall have the same time domain behavior.

The following can be configured via higher layer signaling for one or more CSI Resource Settings for channel and interference measurement:
CSI-IM resource for interference measurement as described in Clause 5.2.2.4.
NZP CSI-RS resource for interference measurement as described in Clause 5.2.2.3.1.
NZP CSI-RS resource for channel measurement as described in Clause 5.2.2.3.1.

The UE may assume that the NZP CSI-RS resource(s) for channel measurement and the CSI-IM resource(s) for interference measurement configured for one CSI reporting can be resource-wise quasi-co-located (QCLed) with respect to ‘typeD’. When NZP CSI-RS resource(s) is used for interference measurement, the UE may assume that the NZP CSI-RS resource for channel measurement and the CSI-IM resource or NZP CSI-RS resource(s) for interference measurement configured for one CSI reporting can be QCLed with respect to ‘typeD’.

For L1-SINR measurement:
When one Resource Setting is configured, the Resource Setting (given by higher layer parameter resourcesForChannelMeasurement) is for channel and interference measurement on NZP CSI-RS for L1-SINR computation. UE may assume that same 1 port NZP CSI-RS resource(s) with density 3 resource elements (REs) and/or resource blocks (RBs) is used for both channel and interference measurements.
When two Resource Settings are configured, the first one Resource Setting (given by higher layer parameter resourcesForChannelMeasurement) is for channel measurement on synchronization signal block (SSB) or NZP CSI-RS and the second one (given by either higher layer parameter csi-IM-ResourcesForInterference or higher layer parameter nzp-CSI-RS-ResourcesForInterference) is for interference measurement performed on CSI-IM or on 1 port NZP CSI-RS with density 3 REs/RB, where each SSB or NZP CSI-RS resource for channel measurement is associated with one CSI-IM resource or one NZP CSI-RS resource for interference measurement by the ordering of the SSB or NZP CSI-RS resource for channel measurement and CSI-IM resource or NZP CSI-RS resource for interference measurement in the corresponding resource sets. The number of SSB(s) or CSI-RS resources for channel measurement equals to the number of CSI-IM resources or the number of NZP CSI-RS resource for interference measurement.
UE may apply the SSB, or ‘typeD’ RS configured with qcl-Type set to ‘typeD’ to the NZP CSI-RS resource for channel measurement, as the reference RS for determining ‘typeD’ assumption for the corresponding CSI-IM resource or the corresponding NZP CSI-RS resource for interference measurement configured for one CSI reporting.
UE may expect that the NZP CSI-RS resource set for channel measurement and the NZP-CSI-RS resource set for interference measurement, if any, can be configured with the higher layer parameter repetition.

For reporting configurations, the UE shall calculate CSI parameters (if reported) assuming the following dependencies between CSI parameters (if reported)
LI shall be calculated conditioned on the reported CQI, PMI, RI and CRI
CQI shall be calculated conditioned on the reported PMI, RI and CRI
PMI shall be calculated conditioned on the reported RI and CRI
RI shall be calculated conditioned on the reported CRI.

The Reporting configuration for CSI can be aperiodic (using physical uplink shared channel (PUSCH)), periodic (using physical uplink control channel (PUCCH)) or semi-persistent (using PUCCH, and DCI activated PUSCH). The CSI-RS Resources can be periodic, semi-persistent, or aperiodic. Table 5.2.1.4-1 shows the supported combinations of CSI Reporting configurations and CSI-RS Resource configurations and how the CSI Reporting is triggered for each CSI-RS Resource configuration. Periodic CSI-RS is configured by higher layers. Semi-persistent CSI-RS is activated and deactivated as described in Clause 5.2.1.5.2. Aperiodic CSI-RS is configured and triggered/activated as described in Clause 5.2.1.5.1.

TABLE 5.2.1.4-1
Triggering/Activation of CSI Reporting for the possible CSI-RS Configurations.

| CSI-RS | Periodic CSI | Semi-Persistent | Aperiodic CSI |
|---|---|---|---|
| Configuration | Reporting | CSI Reporting | Reporting |
| Periodic CSI-RS | No dynamic | For reporting on | Triggered by DCI; |
| | triggering/activation | PUCCH, the UE | additionally, |
| | | receives an | subselection |
| | | activation | indication as |
| | | command, as | described in clause |
| | | described in clause | 6.1.3.13 of [10, TS |
| | | 6.1.3.16 of [10, TS | 38.321] possible as |
| | | 38.321]; for | defined in Clause |
| | | reporting on | 5.2.1.5.1. |
| | | PUSCH, the UE | |
| | | receives triggering | |
| | | on DCI | |
| Semi-Persistent | Not Supported | For reporting on | Triggered by DCI; |
| CSI-RS | | PUCCH, the UE | additionally, |
| | | receives an | subselection |
| | | activation | indication as |
| | | command, as | described in clause |
| | | described in clause | 6.1.3.13 of [10, TS |
| | | 6.1.3.16 of [10, TS | 38.321] possible as |
| | | 38.321]; for | defined in Clause |
| | | reporting on | 5.2.1.5.1. |
| | | PUSCH, the UE | |
| | | receives triggering | |
| | | on DCI | |
| Aperiodic CSI-RS | Not Supported | Not Supported | Triggered by DCI; |
| | | | additionally, |
| | | | subselection |
| | | | indication as |
| | | | described in clause |
| | | | 6.1.3.13 of [10, TS |
| | | | 38.321] possible as |
| | | | defined in Clause |
| | | | 5.2.1.5.1. |

When the UE is configured with higher layer parameter NZP-CSI-RS-ResourceSet and when the higher layer parameter repetition is set to ‘off’, the UE shall determine a CRI from the supported set of CRI values as defined in Clause 6.3.1.1.2 of [5, TS 38.212] and report the number in each CRI report. When the higher layer parameter repetition is set to ‘on’, CRI is not reported. CRI reporting is not supported when the higher layer parameter codebookType is set to either ‘typeII’, ‘typeII-PortSelection’, ‘typeII-r16’ or to ‘typeII-PortSelection-r16’.

For a periodic or semi-persistent CSI report on PUCCH, the periodicity T_{CSI} (measured in slots) and the slot offset T_{offset} can be configured by the higher layer parameter reportSlotConfig. Unless specified otherwise, the UE shall transmit the CSI report in frames with system frame number (SFN) n_{f} and slot number within the frame

$${n}_{s f}^{μ}$$

satisfying

$$( {N}_{slot}^{frame , μ} {n}_{f} + {n}_{s , f}^{μ} - {T}_{offset} ) mod {T}_{CSI} = 0$$

where μ is the sub-carrier spacing (SCS) configuration of the uplink BWP the CSI report is transmitted on.

For a semi-persistent CSI report on PUSCH, the periodicity T_{CSI} (measured in slots) is configured by the higher layer parameter reportSlotConfig. Unless specified otherwise, the UE shall transmit the CSI report in frames with SFN n_{f} and slot number within the frame

$${n}_{s , f}^{μ}$$

satisfying

$$( {N}_{slot}^{frame , μ} ( {n}_{f} - {n}_{f}^{start} ) + {n}_{s , f}^{μ} - {n}_{s , f}^{start} ) mod {T}_{CSI} = 0$$

where

$${n}_{f}^{start} and {n}_{s , f}^{start}$$

can be the SFN and slot number within the frame respectively of the initial semi-persistent PUSCH transmission according to the activating DCI.

For a semi-persistent or aperiodic CSI report on PUSCH, the allowed slot offsets can be configured by the following higher layer parameters:
if triggered/activated by DCI format 0_2 and the higher layer parameter reportSlotOffsetListDCI-0-2 is configured, the allowed slot offsets can be configured by reportSlotOffsetListDCI-0-2, and
if triggered/activated by DCI format 0_1 and the higher layer parameter reportSlotOffsetListDCI-0-1 is configured, the allowed slot offsets can be configured by reportSlotOffsetListDCI-0-1, and
otherwise, the allowed slot offsets can be configured by the higher layer parameter reportSlotOffsetList.
   The offset is selected in the activating/triggering DCI.

For CSI reporting, a UE can be configured via higher layer signaling with one out of two possible subband sizes, where a subband is defined as

$${N}_{PRB}^{SB}$$

contiguous physical resource blocks (PRBs) and depends on the total number of PRBs in the bandwidth part according to Table 5.2.1.4-2.

TABLE 5.2.1.4-2
Configurable subband sizes

| Bandwidth part (PRBs) | Subband size (PRBs) |
|---|---|
| 24-72 | 4, 8 |
| 73-144 | 8, 16 |
| 145-275 | 16, 32 |

The reportFreqConfiguration contained in a CSI-ReportConfig indicates the frequency granularity of the CSI Report. A CSI Reporting Setting configuration defines a CSI reporting band as a subset of subbands of the bandwidth part, where the reportFreqConfiguration indicates:
the csi-ReportingBand as a contiguous or non-contiguous subset of subbands in the bandwidth part for which CSI shall be reported.
   A UE is not expected to be configured with csi-ReportingBand which contains a subband where a CSI-RS resource linked to the CSI Report setting has the frequency density of each CSI-RS port per PRB in the subband less than the configured density of the CSI-RS resource.
   If a CSI-IM resource is linked to the CSI Report Setting, a UE is not expected to be configured with csi-ReportingBand which contains a subband where not all PRBs in the subband have the CSI-IM REs present.
wideband CQI or subband CQI reporting, as configured by the higher layer parameter cqi-FormatIndicator. When wideband CQI reporting is configured, a wideband CQI is reported for each codeword for the entire CSI reporting band. When subband CQI reporting is configured, one CQI for each codeword is reported for each subband in the CSI reporting band.
wideband PMI or subband PMI reporting as configured by the higher layer parameter pmi-FormatIndicator. When wideband PMI reporting is configured, a wideband PMI is reported for the entire CSI reporting band. When subband PMI reporting is configured, except with 2 antenna ports, a single wideband indication (i₁ in Clause 5.2.2.2) is reported for the entire CSI reporting band and one subband indication (i₂ in clause 5.2.2.2) is reported for each subband in the CSI reporting band. When subband PMIs can be configured with 2 antenna ports, a PMI is reported for each subband in the CSI reporting band.
   a UE is not expected to be configured with pmi-FormatIndicator if codebookType is set to ‘typeII-r16’ or ‘typeII-PortSelection-r16’.

A CSI Reporting Setting is said to have a wideband frequency-granularity if
reportQuantity is set to ‘cri-RI-PMI-CQI’, or ‘cri-RI-LI-PMI-CQI’, cqi-FormatIndicator is set to ‘widebandCQI’ and pmi-FormatIndicator is set to ‘widebandPMI’, or
reportQuantity is set to ‘cri-RI-i1’ or
reportQuantity is set to ‘cri-RI-CQI’ or ‘cri-RI-i1-CQI’ and cqi-FormatIndicator is set to ‘widebandCQI’, or
reportQuantity is set to ‘cri-RSRP’ or ‘ssb-Index-RSRP’ or ‘cri-SINR’, or ‘ssb-Index-SINR’
   otherwise, the CSI Reporting Setting is said to have a subband frequency-granularity.

If the UE is configured with a CSI Reporting Setting for a bandwidth part with fewer than 24 PRBs, the CSI reporting setting is expected to have a wideband frequency-granularity, and, if applicable, the higher layer parameter codebookType is set to ‘typeI-SinglePanel’.

For resource setting configuration, for aperiodic CSI, if groupBasedBeamReporting-r17 is not configured, each trigger state configured using the higher layer parameter CSI-AperiodicTriggerState is associated with one or multiple CSI-ReportConfig where each CSI-ReportConfig is linked to periodic, or semi-persistent, or aperiodic resource setting(s):
When one Resource Setting is configured, the Resource Setting (given by higher layer parameter resourcesForChannelMeasurement) is for channel measurement for L1-RSRP or for channel and interference measurement for L1-SINR computation.
When two Resource Settings can be configured, the first one Resource Setting (given by higher layer parameter resourcesForChannelMeasurement) is for channel measurement and the second one (given by either higher layer parameter csi-IM-ResourcesForInterference or higher layer parameter nzp-CSI-RS-ResourcesForInterference) is for interference measurement performed on CSI-IM or on NZP CSI-RS.
When three Resource Settings can be configured, the first Resource Setting (higher layer parameter resourcesForChannelMeasurement) is for channel measurement, the second one (given by higher layer parameter csi-IM-ResourcesForInterference) is for CSI-IM based interference measurement and the third one (given by higher layer parameter nzp-CSI-RS-ResourcesForInterference) is for NZP CSI-RS based interference measurement.

For aperiodic CSI, and for periodic and semi-persistent CSI resource settings, if groupBasedBeamReporting-r17 is configured, each trigger state configured using the higher layer parameter CSI-AperiodicTriggerState is associated with one or multiple CSI-ReportConfig where each CSI-ReportConfig is linked to periodic or semi-persistent, setting(s):
When one Resource Setting is configured, the Resource setting is given by resourcesForChannelMeasurement for LI-RSRP measurement. In such a case, the number of configured CSI Resource Sets in the Resource Setting is S=2

For aperiodic CSI, and for aperiodic CSI resource settings, if groupBasedBeamReporting-r17 is configured, each trigger state configured using the higher layer parameter CSI-AperiodicTriggerState is associated with resourcesForChannel and resourcesForChannel2, which correspond to first and second resource sets, respectively, for L1-RSRP measurement.

For semi-persistent or periodic CSI, each CSI-ReportConfig is linked to periodic or semi-persistent Resource Setting(s):
When one Resource Setting (given by higher layer parameter resourcesForChannelMeasurement) is configured, the Resource Setting is for channel measurement for L1-RSRP or for channel and interference measurement for L1-SINR computation.
When two Resource Settings can be configured, the first Resource Setting (given by higher layer parameter resourcesForChannelMeasurement) is for channel measurement and the second Resource Setting (given by higher layer parameter csi-IM-ResourcesForInterference) is used for interference measurement performed on CSI-IM. For LI-SINR computation, the second Resource Setting (given by higher layer parameter csi-IM-ResourcesForInterference or higher layer parameter nzp-CSI-RS-ResourceForInterference) is used for interference measurement performed on CSI-IM or on NZP CSI-RS.

A UE is not expected to be configured with more than one CSI-RS resource in resource set for channel measurement for a CSI-ReportConfig with the higher layer parameter codebookType set to ‘typeII’, ‘typeII-PortSelection’, ‘typeII-r16’, ‘typeII-PortSelection-r16’, or ‘typeII-PortSelection-r17’. A UE is not expected to be configured with more than 64 NZP CSI-RS resources and/or SS/PBCH block resources in resource setting for channel measurement for a CSI-ReportConfig with the higher layer parameter reportQuantity set to ‘none’, ‘cri-RI-CQI’, ‘cri-RSRP’, ‘ssb-Index-RSRP’; ‘cri-SINR’ or ‘ssb-Index-SINR’. If interference measurement is performed on CSI-IM, each CSI-RS resource for channel measurement is resource-wise associated with a CSI-IM resource by the ordering of the CSI-RS resource and CSI-IM resource in the corresponding resource sets. The number of CSI-RS resources for channel measurement equals to the number of CSI-IM resources.

An NZP CSI-RS Resource Set for channel measurement with 2≤Kₛ≤8 resources can be configured with two Resource Groups, with K₁≥1 resources in Group 1 and K₂≥1 resources in Group 2, such that K₁+K₂=Kₛ, and with N∈{1,2} Resource Pairs. Each Resource Pair consists of one resource from Group 1 and one resource from Group 2. The same resource can be associated with two Resource Pairs in frequency range 1 but not in frequency range 2.

Except for L1-SINR, if interference measurement is performed on NZP CSI-RS, a UE does not expect to be configured with more than one NZP CSI-RS resource in the associated resource set within the resource setting for channel measurement. Except for L1-SINR, the UE configured with the higher layer parameter nzp-CSI-RS-ResourcesForInterference may expect no more than 18 NZP CSI-RS ports configured in a NZP CSI-RS resource set.

For CSI measurement(s) other than L1-SINR, a UE assumes:
each NZP CSI-RS port configured for interference measurement corresponds to an interference transmission layer.
all interference transmission layers on NZP CSI-RS ports for interference measurement take into account the associated energy per resource element (EPRE) ratios configured in 5.2.2.3.1;
other interference signal on REs of NZP CSI-RS resource for channel measurement, NZP CSI-RS resource for interference measurement, or CSI-IM resource for interference measurement.

For L1-SINR measurement with dedicated interference measurement resources, a UE assumes:
the total received power on dedicated NZP CSI-RS resource for interference measurement or dedicated CSI-IM resource for interference measurement corresponds to interference and noise.

For report quantity configurations, a UE may be configured with a CSI-ReportConfig with the higher layer parameter reportQuantity set to either ‘none’, ‘cri-RI-PMI-CQI’, ‘cri-RI-i1’, ‘cri-RI-i1-CQI’, ‘cri-RI-CQI’, ‘cri-RSRP’, ‘cri-SINR’, ‘ssb-Index-RSRP’, ‘ssb-Index-SINR’ or ‘cri-RI-LI-PMI-CQI’. If the UE is configured with a CSI-ReportConfig with the higher layer parameter reportQuantity set to ‘none’, then the UE shall not report any quantity for the CSI-ReportConfig.

If the UE is configured with a CSI-ReportConfig with the higher layer parameter reportQuantity set to ‘cri-RI-PMI-CQI’, or ‘cri-RI-LI-PMI-CQI’, the UE shall report a preferred precoder matrix for the entire reporting band, or a preferred precoder matrix per subband, according to Clause 5.2.2.2.

If the UE is configured with a CSI-ReportConfig with the higher layer parameter reportQuantity set to ‘cri-RI-i1’,
the UE expects, for that CSI-ReportConfig, to be configured with higher layer parameter codebookType set to ‘typeI-SinglePanel’ and pmi-FormatIndicator set to ‘widebandPMI’ and,
the UE shall report a PMI consisting of a single wideband indication (i₁ in Clause 5.2.2.2.1) for the entire CSI reporting band.

If the UE is configured with a CSI-ReportConfig with the higher layer parameter reportQuantity set to ‘cri-RI-i1-CQI’,
the UE expects, for that CSI-ReportConfig, to be configured with higher layer parameter codebookType set to ‘typeI-SinglePanel’ and pmi-FormatIndicator set to ‘widebandPMI’ and,
the UE shall report a PMI consisting of a single wideband indication (i₁ in Clause 5.2.2.2.1) for the entire CSI reporting band. The CQI is calculated conditioned on the reported i₁ assuming physical downlink shared channel (PDSCH) transmission with Nₚ≥1 precoders (corresponding to the same i₁ but different i₂ in Clause 5.2.2.2.1), where the UE assumes that one precoder is randomly selected from the set of Nₚ precoders for each precoding resource block group (PRG) on PDSCH, where the PRG size for CQI calculation is configured by the higher layer parameter pdsch-BundleSizeForCSL.

If the UE is configured with a CSI-ReportConfig with the higher layer parameter reportQuantity set to ‘cri-RI-CQI’,
if the UE is configured with higher layer parameter non-PMI-PortIndication contained in a CSI-ReportConfg, r ports can be indicated in the order of layer ordering for rank r and each CSI-RS resource in the CSI resource setting is linked to the CSI-ReportConfig based on the order of the associated NZP-CSI-RS-ResourceId in the linked CSI resource setting for channel measurement given by higher layer parameter resourcesForChannelMeasurement. The configured higher layer parameter non-PMI-PortIndication contains a sequence

$${p}_{0}^{( 1 )} , {p}_{0}^{( 2 )} , {p}_{1}^{( 2 )} , {p}_{0}^{( 3 )} , {p}_{1}^{( 3 )} , {p}_{2}^{( 3 )} , … , {p}_{0}^{( R )} , {p}_{1}^{( R )} , … , {p}_{R - 1}^{( R )}$$

of port indices, where

$${p}_{0}^{( ν )} , … , {p}_{ν - 1}^{( ν )}$$

can be the CSI-RS port indices associated with rank v and R∈{1,2, . . . , P} where P∈{1,2,4,8} is the number of ports in the CSI-RS resource. The UE shall only report RI corresponding to the configured fields of PortIndexFor8Ranks.
if the UE is not configured with higher layer parameter non-PMI-PortIndication, the UE assumes, for each CSI-RS resource in the CSI resource setting linked to the CSI-ReportConfig, that the CSI-RS port indices

$${p}_{0}^{( ν )} , … , {p}_{ν - 1}^{( ν )} = \{ 0 , … , ν - 1 \}$$

can be associated with ranks v=1, 2, . . . , P where P∈{1,2,4,8} is the number of ports in the CSI-RS resource.
When calculating the CQI for a rank, the UE shall use the ports indicated for that rank for the selected CSI-RS resource. The precoder for the indicated ports shall be assumed to be the identity matrix scaled by

$$\frac{1}{\sqrt{v}} .$$

If the UE is configured with a CSI-ReportConfig with the higher layer parameter reportQuantity set to ‘cri-RSRP’ or ‘ssb-Index-RSRP’,
if the UE is configured with the higher layer parameter groupBasedBeamReporting set to ‘disabled’, the UE is not required to update measurements for more than 64 CSI-RS and/or SSB resources, and the UE shall report in a single report nrofReportedRS (higher layer configured) different CRI or SSBRI for each report setting.
if the UE is configured with the higher layer parameter groupBasedBeamReporting set to ‘enabled’, the UE is not required to update measurements for more than 64 CSI-RS and/or SSB resources, and the UE shall report in a single reporting instance two different CRI or SSBRI for each report setting, where CSI-RS and/or SSB resources can be received simultaneously by the UE either with a single spatial domain receive filter, or with multiple simultaneous spatial domain receive filters.
if the UE is configured with the higher layer parameter groupBasedBeamReporting-r17, the UE is not required to update measurements for more than 64 CSI-RS and/or SSB resources, and the UE shall report in a single reporting instance nrofReportedRSgroup, if configured, group(s) of two CRIs or SSBRIs selecting one CSI-RS or SSB from each of the two CSI Resource Sets for the report setting, where CSI-RS and/or SSB resources of each group can be received simultaneously by the UE.

If the UE is configured with a CSI-ReportConfig with the higher layer parameter reportQuantity set to ‘cri-SINR’ or ‘ssb-Index-SINR’,
if the UE is configured with the higher layer parameter groupBasedBeamReporting set to ‘disabled’, the UE shall report in a single report nrofReportedRS (higher layer configured) different CRI or SSBRI for each report setting.
if the UE is configured with the higher layer parameter groupBasedBeamReporting set to ‘enabled’, the UE shall report in a single reporting instance two different CRI or SSBRI for each report setting, where CSI-RS and/or SSB resources can be received simultaneously by the UE.

In some wireless communications systems, wireless communication designs are built on the plane-electromagnetic wave. However, an electromagnetic (EM) wave possesses not only linear momentum, but also angular momentum, which contains either the spin angular momentum (SAM) or OAM. OAM is a wavefront with helical phase OAM and has a great number of topological charges, that are referred as OAM modes. Beams with different OAM-modes are orthogonal to each other and they can be multiplexed/demultiplexed together, thus increasing the capacity without relying on the traditional resources such as time and frequency.

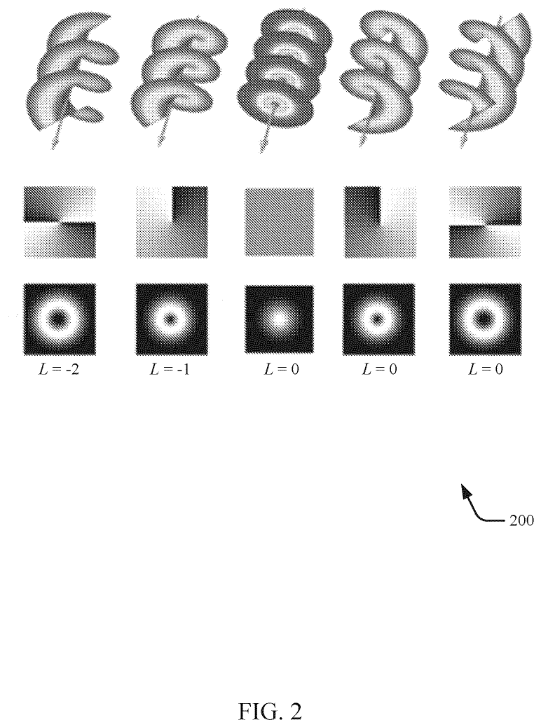

FIG. 2 depicts OAM modes 200 including five different OAM modes L of an OAM wave. (Ref: Wikipedia by E-karimi, licensed under Create Commons BY-SA 3.0, https://en.wikipedia.org/wiki/Orbital angular momentum of light). OAM is formed by microscopic particles moving in a circle along the propagation direction, which is related to the spatial distribution of particles. It is macroscopically represented as a vortex beam carrying the wavefront phase factor exp(jIϕ), with “L” being the topological charge of the wave or azimuthal order or index, or even the roll index and determines the number of OAM modes, and “ϕ” represents emission phase angle or roll angle.

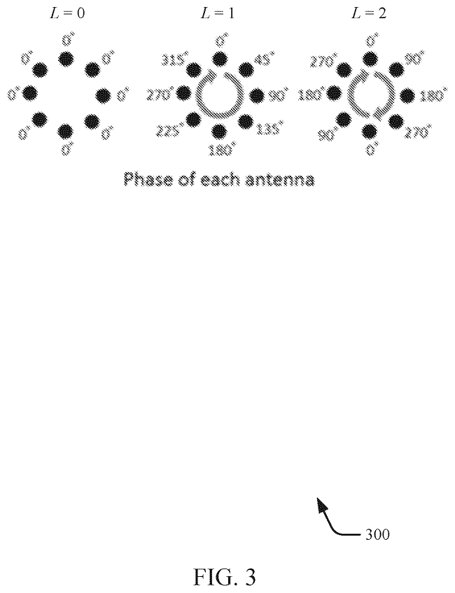

FIG. 3 illustrates example beam generation 300 for OAM modes. The beam generation 300, for instance, includes OAM modes 0, 1, and 2 using uniform circular arrays (UCA) comprised of 8 antenna elements. (Ref: Applied Science 2019, 9, 1729; doi:10.3390/app9091729, licensed under Creative Commons BY 4.0). To generate the beam carrying the OAM mode n (L=n), antenna elements can be connected with phase shifters that make n×360 degrees of rotation. For instance, UCA of antenna elements can be used for OAM mode transmission and reception. Note that a single UCA or multiple UCAs can be used for multiple OAM mode generation. In the former case, superposed beams can be transmitted by a single UCA. In the latter case, concentric multiple UCAs can be used. The separation of beams carrying OAM modes can be done in a way similar to that for generation using antenna elements connected with phase shifters that make opposite rotation directions. For instance, when the number of antenna elements used is larger than 2n, rotations of n×360 degrees are orthogonal to one another. Therefore, each OAM mode can be separated from mixed OAM modes' signals without aliasing. Such beam separation can also be done by using a single UCA or multiple UCAs as in the beam generation.

In aspects of multiple mode OAM, UE configuration for operation and reporting for OAM modes is provided. For instance, a network transmits to a UE channel state CSI-RS configuration associated with multiple OAM modes. The resources for CSI can be configured in time, frequency, and code division domains and also in an angular wave propagation domain corresponding to different modes of OAM. This provides, for example, an additional orthogonal dimension to increase a number of orthogonal ports. For instance, the same time, frequency and code domain resources may be used for each of the orthogonal angular modes of OAM.

This type of resource mapping can be advantageous where multiple modes are simultaneously excited. For instance, if OAM is applied to existing wireless frameworks, this can enable a single-port CSI-RS to occupy a single resource element within a block corresponding to one resource block in a frequency domain, one slot in a time domain, and one OAM mode in the angular domain. Further, multi-port CSI-RS can enable multiple orthogonally transmitted per antenna-port CSI-RS to share an overall set of resource elements assigned for configured multi-port CSI-RS. For instance, in addition to code, frequency and time domain sharing, angular domain sharing (OAM modes) can also be included. Angular domain sharing, for example, enables different per-antenna-port CSI-RS to be transmitted on a same set of resource elements with separation achieved by modulating the CSI-RS with different OAM modes.

In implementations, a relationship between different domains (e.g., frequency, time, and OAM domains) is embedded in a CSI-RS sequence generation procedure where CSI-RS sequences for different OAM modes are separately generated and may be pre-defined. In such scenarios, OAM mode number information can be used to differentiate CSI-RS sequences at the receiver, where this may be configured through RRC. In at least one implementation, the CSI-RS for each of the OAM modes may be generated by a different type of sequence, e.g., Gold, Golay, etc. In an alternative or additional implementation, CSI-RS are additionally scrambled with other sequences, where each sequence represents an OAM mode, such as to distinguish between different OAM mode RS. Further, the CSI-RS for each of the OAM modes may be generated by the same sequence type but of different lengths.

In implementations, OAM mode-specific information is used in initialization of each of the CSI-RS sequences to identify different CSI sequenced for different OAM modes. For example, using current CSI-RS generation procedure, a UE can assume the reference-signal sequence r(m) that is defined by

$$r ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) )$$

where the pseudo-random sequence c(i) can be defined by a length-31 Gold sequence. In the case of OAM, the pseudo-random sequence generator may be initialised with

$${c}_{init} = ( {2}^{10} ( {N}_{symb}^{slot} {n}_{s , f}^{μ} + l + b + 1 ) ( 2 {n}_{ID} + 1 ) + {n}_{ID} ) mod {2}^{31}$$

at the start of each orthogonal frequency division multiplexing (OFDM) symbol where

$${n}_{s , f}^{μ}$$

is the slot number within a radio frame, l is the OFDM symbol number within a slot, b is the OAM mode number, and n_{ID} equals the higher-layer parameter scramblingID or sequenceGenerationConfig. The information of mode number may additionally be configured by RRC signalling while configuring the CSI-RS parameters.

In implementations, a UE may be configured such that the CSI-RS is mapped to the frequency, time, angular (e.g., OAM modes) resource elements for each CSI-RS configured. For example, the UE may assume the above sequence r(m) is being mapped to resources elements (k, l, b)_{p,μ} according to

$${a}_{k , l , b}^{( p , u )} = {β}_{CSIRS} {w}_{f} ( {k}^{′} ) \cdot {w}_{t} ( {l}^{′} ) \cdot {r}_{l , b , {n}_{s , f}}$$

$${m}^{′} = ⌊ n α ⌋ + {k}^{′} + ⌊ \frac{\overline{k} ρ}{{N}_{sc}^{RB}} ⌋$$

$$k = {nN}_{sc}^{RB} + \overline{k} + {k}^{′}$$

$$l = \overline{l} + {l}^{′}$$

$$α = \{ \begin{matrix}ρ & for X = 1 \\ 2 ρ & for X > 1\end{matrix}$$

$$n = 0 , 1 , …$$

where k denotes the resource element location in the frequency domain.

In implementations, in addition to time and frequency domain, CDM between different per-antenna port CSI-RS can be extended in the angular domain, e.g., for an OAM mode. Adding a 3^{rd} dimension adds to a number of ports and provides flexibility to configure CSI resources to multiple UEs. In such scenarios, a sequence mapping to the resource elements can be

$${a}_{k , l , b}^{( p , u )} = {β}_{CSIRS} {w}_{f} ( {k}^{′} ) \cdot {w}_{t} ( {l}^{′} ) \cdot {w}_{a} ( {b}^{′} ) \cdot {r}_{l , b , {n}_{s , f}}$$

where wₜ(l′) and w_{f}(k′) define the CDM orthogonal sequence in time and frequency while wₐ(b′) defines the orthogonal sequence in angular domain, e.g., OAM mode.

In implementations, an OAM mode number b is configured through RRC using a bit table, where based on a specified number of defined OAM modes, a bit table corresponding to the mode number may be defined. For instance, zero OAM mode may be used as reference and an index value corresponding to other modes may be used, e.g., for a zero OAM mode no value is indicated and is considered as a default mode. In an example of 5 OAM modes that are defined by positive and negative integer numbers (e.g., −2, −1, 0, 1, 2), a two-bit table may be used indicating OAM modes, −2, −1, 1, 2.

In implementations, specific antenna ports can be associated for each of different OAM modes. For example, two CSI-RS antenna ports (e.g., on different CDM groups) in a CSI-RS resource may be associated with different OAM mode indices. In at least one implementation, a new mapping of antenna ports is configured where in addition to time and frequency indices, OAM mode indices are also used to map the CSI resources to antenna ports.

In implementations, a configuration of mapping to physical resources includes a pattern for different OAM modes according to which the sequence values are mapped to different modes, different time symbols, different resource elements (RE), or combinations thereof. For example, the pattern is defined via the indexing of the a as

$${a}_{k , l , b}^{( p , u )} or {a}_{k , b , l}^{( p , u )} or {a}_{b , k , l}^{( p , u )} .$$

In implementations, a single OAM mode is excited at one time resource. Thus, a mapping of CSI-RS resources can be done to enable OAM mode flexibility, with an addition of an indication of an active OAM mode. In some examples, CSI-RS resources are defined with multiple time patterns, where each time pattern corresponds to an indicated OAM mode.

In implementations, CSI resources can be configured such that each CSI resource identifier (ID) is associated with at least one OAM mode. For example, CSI-RS ID1 can be associated with time and frequency resource 1, beam 1, and/or OAM mode 1. Such implementations are particularly beneficial where OAM modes are separated in time, where such association may be configured through RRC signalling. For example, this may be configured through an NZP-CSI-RS-Resource information element, where OAM mode in the configuration may either be determined explicitly (e.g., with an indication of OAM mode in the configuration), or in association with a default and/or implicitly linked OAM mode type such as OAM modes obtained during initial access. If no OAM mode is indicated, a default mode such as mode 0 may be determined by a UE.

In implementations, CSI configurations with OAM modes can be aperiodic (e.g., using PUSCH), periodic (e.g., using PUCCH), or semi-persistent (e.g., using PUCCH and DCI activated PUSCH). For instance, a new RS type can be configured for OAM mode-based measurements that can be periodic, aperiodic and semi-persistent. In implementations, CSI-RS resource configuration includes an indication of a plurality of OAM modes for which a receiver can perform CSI measurements, report the obtained measurements, or a combination thereof.

Implementations also provide for CSI reporting with OAM mode indications. CSI reporting, for example, can be enhanced to indicate channel characteristics corresponding to different OAM modes. For instance, CSI resources corresponding to one and/or multiple OAM modes can be configured to a UE by a network concurrently (e.g., at the same time) or separately, e.g., at different time indices. In implementations, propagation channel-related quantities (e.g., CQI, PMI, and RI) can be additionally coupled with an OAM mode and indicated in a report that indicates which quantity corresponds to which OAM mode. Further, the report quantities can be enhanced to indicate a corresponding OAM mode for a quantity. For example, a UE may be configured with CSI reporting configuration information element (e.g., CSI-ReportConfig) with a higher layer parameter reportQuantity set to a value such as ‘cri-RI-PMI-CQI-Modei’, ‘cri-RI-CQI-Modei’, ‘cri-RI-LI-PMI-CQI-Modei’ or ‘Modei’, where the abbreviation Modei (OAM mode index) represents an example to indicate an OAM mode in the quantities to be reported by the UE.

In implementations, OAM modes may be reported by a UE using a separate field in a report, for example, reportModelQuantity, where inclusion of this field may be configured through RRC signalling for example in the CSI-ReportConfig or using a lower layer signaling. Based on the measurements, the UE can indicate at least one index corresponding to a single or multiple OAM modes.

In implementations, a UE is configured to report a list of OAM modes according to channel conditions. For instance, OAM modes may be reported in a sequential order, e.g., in decreasing order of signal quality. Based on a report, a network can determine which mode is suited for which UE. A UE, for example, sends multiple reports with each report specific to a particular OAM mode. Alternatively or additionally, a single report can be used for reporting on multiple OAM modes.

In implementations, OAM reporting mechanisms may be indicated to a UE by the same RRC signalling that is used for configuration of CSI reporting. Further, an OAM reporting mechanism can be autonomously chosen by a UE or can be based on the CSI resource configuration. For instance, where CSI resources for multiple modes are orthogonal in an OAM mode domain, then a single report may be used to define channel properties for different OAM modes. If configured CSI resources for different OAM modes utilize different time resources, then different reports may be used to indicate channel properties for OAM modes.

In implementations, a CSI report can include an indication of a number of observed non-zero OAM modes at a receiver, such as according to an OAM mode reporting configuration. For OAM mode reporting, for instance, a network may indicate an OAM mode energy threshold. As part of OAM mode reporting, a UE may communicate information on a set of supported OAM modes for transmission, for reception, or both transmission and reception. Further, a UE may report supported OAM modes to the network via a UE capability information element. In at least some implementations, a UE reporting OAM mode information can indicate a preference for a specific OAM mode and/or set of OAM modes.

In implementations, a UE can be configured to measure and report a measure of OAM mode dispersion as part of CSI measurement and reporting. For instance, based on measured OAM mode dispersion, energy of an excited OAM mode at a UE transmitter can be spread to other OAM modes at a UE receiver.

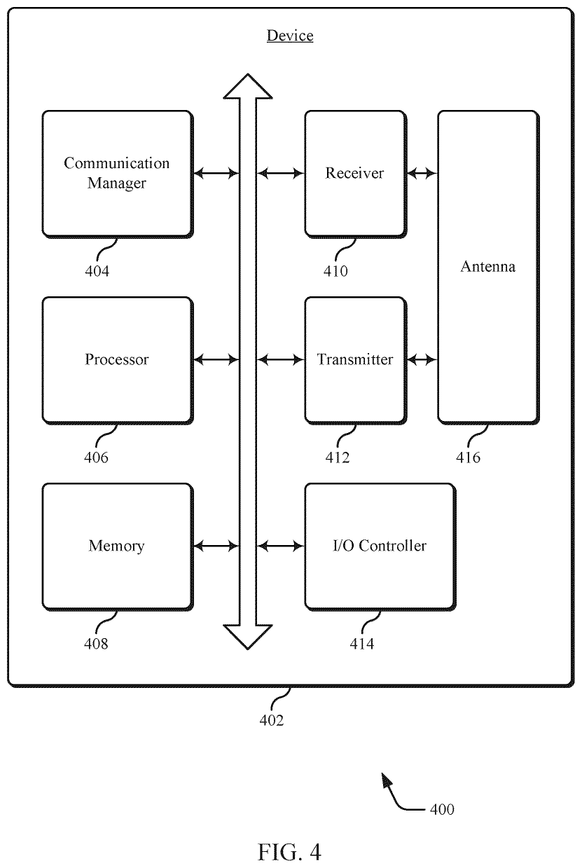

FIG. 4 illustrates an example of a block diagram 400 of a device 402 that supports multiple mode OAM in accordance with aspects of the present disclosure. The device 402 may be an example of a UE 104 as described herein. The device 402 may support wireless communication and/or network signaling with one or more base stations 102, other UEs 104, network entities and devices, or any combination thereof. The device 402 may include components for bi-directional communications including components for transmitting and receiving communications, such as a communications manager 404, a processor 406, a memory 408, a receiver 410, a transmitter 412, and an I/O controller 414. These components may be in electronic communication or otherwise coupled (e.g., operatively, communicatively, functionally, electronically, electrically) via one or more interfaces (e.g., buses).

The communications manager 404, the receiver 410, the transmitter 412, or various combinations thereof or various components thereof may be examples of means for performing various aspects of the present disclosure as described herein. For example, the communications manager 404, the receiver 410, the transmitter 412, or various combinations or components thereof may support a method for performing one or more of the functions described herein.

In some implementations, the communications manager 404, the receiver 410, the transmitter 412, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 406 and the memory 408 coupled with the processor 406 may be configured to perform one or more of the functions described herein (e.g., by executing, by the processor 406, instructions stored in the memory 408).

Additionally or alternatively, in some implementations, the communications manager 404, the receiver 410, the transmitter 412, or various combinations or components thereof may be implemented in code (e.g., as communications management software or firmware) executed by the processor 406. If implemented in code executed by the processor 406, the functions of the communications manager 404, the receiver 410, the transmitter 412, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 404 may be configured to perform various operations (e.g., receiving, monitoring, transmitting) using or otherwise in cooperation with the receiver 410, the transmitter 412, or both. For example, the communications manager 404 may receive information from the receiver 410, send information to the transmitter 412, or be integrated in combination with the receiver 410, the transmitter 412, or both to receive information, transmit information, or perform various other operations as described herein. Although the communications manager 404 is illustrated as a separate component, in some implementations, one or more functions described with reference to the communications manager 404 may be supported by or performed by the processor 406, the memory 408, or any combination thereof. For example, the memory 408 may store code, which may include instructions executable by the processor 406 to cause the device 402 to perform various aspects of the present disclosure as described herein, or the processor 406 and the memory 408 may be otherwise configured to perform or support such operations.

For example, the communications manager 404 may support wireless communication and/or network signaling at a device (e.g., the device 402, a UE) in accordance with examples as disclosed herein. The communications manager 404 and/or other device components may be configured as or otherwise support an apparatus, such as a UE, including a transceiver; a processor coupled to the transceiver, the processor and the transceiver configured to cause the apparatus to: receive, from a network device, configuration information for CSI-RS indicating OAM mode resources; and transmit, to the network device, wireless signal using a subset of the OAM mode resources and based at least in part on OAM mode-based measurements for the subset of the OAM mode resources.

Additionally, the apparatus (e.g., a UE) includes any one or combination of: where the configuration information for the CSI-RS further includes at least one of a time resource, a frequency resource, a time-domain behavior, an OAM mode index, a usage type corresponding to an RS transmission, an RS reception, or combinations thereof; where the configuration information for the CSI-RS is configured such that at least some of the RS correspond to an OAM mode index; where the configuration information for the CSI-RS is configured such that at least some of the RS correspond to a different type of sequence generation method for each of the OAM mode resources; where the configuration information for the CSI-RS is configured such that at least some of the RS are initialized with OAM mode-specific index information for different OAM modes; where the configuration information for the CSI-RS is configured such that CDM between different per-antenna port CSI-RS is extended in an OAM mode domain; where the configuration information for the CSI-RS is configured such that an OAM mode number index is configured through RRC signaling using a bit table; where the configuration information for the CSI-RS is configured such that different antenna ports are associated with different OAM modes; where the configuration information for the CSI-RS is configured to include CSI resource identifiers, and where each CSI resource identifier is associated with at least one OAM mode; where the configuration information for the CSI-RS is configured such that CSI configurations with OAM modes are one or more of aperiodic, periodic, or semi-persistent; where the apparatus receives, from the network apparatus, a report configuration for the OAM mode resources; and transmits, based at least in part on the report configuration, a report to the network apparatus including OAM mode-based measurements for one or more RS of the OAM mode resources; where a report for each RS of a plurality of RS indicates at least an OAM mode based on OAM mode-based channel measurements; where the apparatus transmits multiple reports, and where each report is specific to an individual OAM mode.

The communications manager 404 and/or other device components may be configured as or otherwise support a means for wireless communication and/or network signaling at a UE, including receiving, from a network device, configuration information for CSI-RS indicating OAM mode resources; and transmitting, to the network device, wireless signal using a subset of the OAM mode resources and based at least in part on OAM mode-based measurements for the subset of the OAM mode resources.

Additionally, wireless communication and/or network signaling at the UE includes any one or combination of: where the configuration information for the CSI-RS further includes at least one of a time resource, a frequency resource, a time-domain behavior, an OAM mode index, a usage type corresponding to an RS transmission, an RS reception, or combinations thereof; where the configuration information for the CSI-RS is configured such that at least some of the RS correspond to an OAM mode index; where the configuration information for the CSI-RS is configured such that at least some of the RS correspond to a different type of sequence generation method for each of the OAM mode resources; where the configuration information for the CSI-RS is configured such that at least some of the RS are initialized with OAM mode-specific index information for different OAM modes; where the configuration information for the CSI-RS is configured such that CDM between different per-antenna port CSI-RS is extended in an OAM mode domain.

Additionally, wireless communication and/or network signaling at the UE includes any one or combination of: where the configuration information for the CSI-RS is configured such that an OAM mode number index is configured through RRC signaling using a bit table; where the configuration information for the CSI-RS is configured such that different antenna ports are associated with different OAM modes; where the configuration information for the CSI-RS is configured to include CSI resource identifiers, and where each CSI resource identifier is associated with at least one OAM mode; where the configuration information for the CSI-RS is configured such that CSI configurations with OAM modes are one or more of aperiodic, periodic, or semi-persistent; further including: receiving, from the network device, a report configuration for the OAM mode resources; and transmitting, based at least in part on the report configuration, a report to the network device including OAM mode-based measurements for one or more RS of the OAM mode resources; where a report for each RS of a plurality of RS indicates at least an OAM mode based on OAM mode-based channel measurements; further including transmitting multiple reports, and where each report is specific to an individual OAM mode.

The communications manager 404 and/or other device components may be configured as or otherwise support an apparatus, such as a UE, including a transceiver; a processor coupled to the transceiver, the processor and the transceiver configured to cause the apparatus to: receive, from a network device, configuration information for CSI-RS indicating at least one OAM mode resource; receive, from the network device, a report configuration for the at least one OAM mode resource; and transmit, based at least in part on the report configuration, a report to the network device including OAM mode-based measurements for one or more references signals of the OAM mode resource.

Additionally, the apparatus (e.g., a UE) includes any one or combination of: where the report configuration is received as part of RRC signaling; where the report includes multiple fields for multiple different OAM modes, and where each field includes an OAM mode-based measurement for a respective OAM mode; where the multiple fields are arranged in the report based at least in part on channel conditions for the different OAM modes; where the apparatus transmits multiple reports, and where each report is specific to an individual OAM mode; where the OAM mode-based measurements include one or more of CQI, PMI, or RI for the OAM mode resource; where the apparatus transmits the report to include channel properties for multiple OAM modes if the multiple OAM modes are orthogonal in an OAM mode domain; and transmits multiple reports to include channel properties for the multiple OAM modes if CSI resources for the multiple OAM modes utilize different respective time resources; where the report includes OAM mode-based measurements for one or more non-zero OAM modes detected at the apparatus and based on the report configuration; where the apparatus transmits OAM information to the network apparatus identifying one or more OAM modes supported by the apparatus; where the OAM information includes one or more of a supported OAM mode for transmission by the apparatus, a supported OAM mode for reception by the apparatus, a preferred OAM mode for transmission by the apparatus, or a preferred OAM mode for reception by the apparatus; where the apparatus measures OAM mode dispersion detected at the apparatus, and to include an indication of the OAM mode dispersion in the report.

The communications manager 404 and/or other device components may be configured as or otherwise support a means for wireless communication and/or network signaling at a UE, including receiving, from a network device, configuration information for CSI-RS indicating at least one OAM mode resource; receiving, from the network device, a report configuration for the at least one OAM mode resource; and transmitting, based at least in part on the report configuration, a report to the network device including OAM mode-based measurements for one or more references signals of the OAM mode resource.

Additionally, wireless communication and/or network signaling at the UE includes any one or combination of: where the report configuration is received as part of RRC signaling; where the report includes multiple fields for multiple different OAM modes, and where each field includes an OAM mode-based measurement for a respective OAM mode; where the multiple fields are arranged in the report based at least in part on channel conditions for the different OAM modes; further including transmitting multiple reports, and where each report is specific to an individual OAM mode; where the OAM mode-based measurements include one or more of CQI, PMI, or RI for the OAM mode resource; further including: transmitting the report to include channel properties for multiple OAM modes if the multiple OAM modes are orthogonal in an OAM mode domain; and transmitting multiple reports to include channel properties for the multiple OAM modes if CSI resources for the multiple OAM modes utilize different respective time resources; where the report includes OAM mode-based measurements for one or more non-zero OAM modes detected based on the report configuration; further including transmitting OAM information to the network device identifying one or more supported OAM modes supported; where the OAM information includes one or more of a supported OAM mode for transmission, a supported OAM mode for reception, a preferred OAM mode for transmission, or a preferred OAM mode for reception; further including measuring OAM mode dispersion, and including an indication of the OAM mode dispersion in the report.

The processor 406 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 406 may be configured to operate a memory array using a memory controller. In some other implementations, a memory controller may be integrated into the processor 406. The processor 406 may be configured to execute computer-readable instructions stored in a memory (e.g., the memory 408) to cause the device 402 to perform various functions of the present disclosure.

The memory 408 may include random access memory (RAM) and read-only memory (ROM). The memory 408 may store computer-readable, computer-executable code including instructions that, when executed by the processor 406 cause the device 402 to perform various functions described herein. The code may be stored in a non-transitory computer-readable medium such as system memory or another type of memory. In some implementations, the code may not be directly executable by the processor 406 but may cause a computer (e.g., when compiled and executed) to perform functions described herein. In some implementations, the memory 408 may include, among other things, a basic I/O system (BIOS) which may control basic hardware or software operation such as the interaction with peripheral components or devices.

The I/O controller 414 may manage input and output signals for the device 402. The I/O controller 414 may also manage peripherals not integrated into the device 402. In some implementations, the I/O controller 414 may represent a physical connection or port to an external peripheral. In some implementations, the I/O controller 414 may utilize an operating system such as iOS®, ANDROID®, MS-DOS®, MS-WINDOWS®, OS/2®, UNIX®, LINUX®, or another known operating system. In some implementations, the I/O controller 414 may be implemented as part of a processor, such as the processor 406. In some implementations, a user may interact with the device 402 via the I/O controller 414 or via hardware components controlled by the I/O controller 414.

In some implementations, the device 402 may include a single antenna 416. However, in some other implementations, the device 402 may have more than one antenna 416, which may be capable of concurrently transmitting or receiving multiple wireless transmissions. The receiver 410 and the transmitter 412 may communicate bi-directionally, via the one or more antennas 416, wired, or wireless links as described herein. For example, the receiver 410 and the transmitter 412 may represent a wireless transceiver and may communicate bi-directionally with another wireless transceiver. The transceiver may also include a modem to modulate the packets, to provide the modulated packets to one or more antennas 416 for transmission, and to demodulate packets received from the one or more antennas 416.

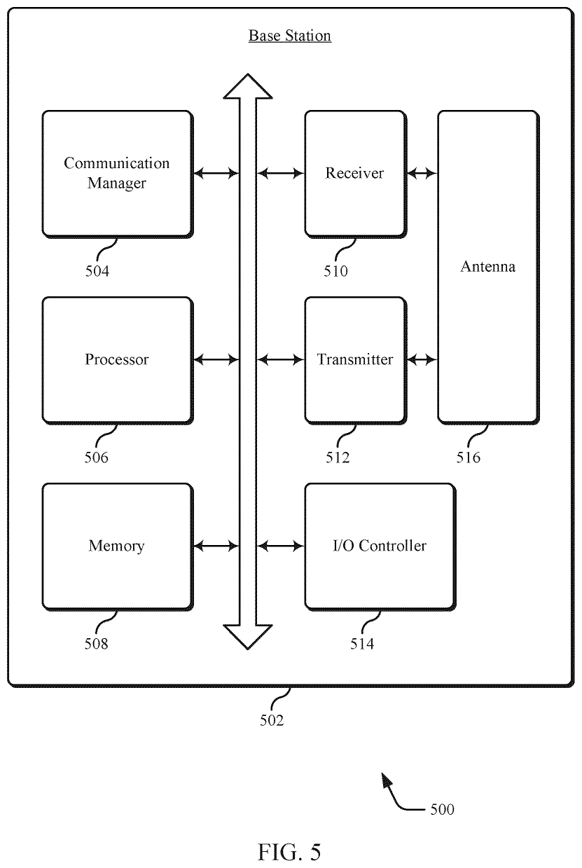

FIG. 5 illustrates an example of a block diagram 500 of a device 502 that supports multiple mode OAM in accordance with aspects of the present disclosure. The device 502 may be an example of a network device (e.g., base station 102, such as a gNB) as described herein. The device 502 may support wireless communication and/or network signaling with one or more base stations 102, other UEs 104, core network devices and functions (e.g., core network 106), or any combination thereof. The device 502 may include components for bi-directional communications including components for transmitting and receiving communications, such as a communications manager 504, a processor 506, a memory 508, a receiver 510, a transmitter 512, and an I/O controller 514. These components may be in electronic communication or otherwise coupled (e.g., operatively, communicatively, functionally, electronically, electrically) via one or more interfaces (e.g., buses).

The communications manager 504, the receiver 510, the transmitter 512, or various combinations thereof or various components thereof may be examples of means for performing various aspects of the present disclosure as described herein. For example, the communications manager 504, the receiver 510, the transmitter 512, or various combinations or components thereof may support a method for performing one or more of the functions described herein.

In some implementations, the communications manager 504, the receiver 510, the transmitter 512, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 506 and the memory 508 coupled with the processor 506 may be configured to perform one or more of the functions described herein (e.g., by executing, by the processor 506, instructions stored in the memory 508).

Additionally or alternatively, in some implementations, the communications manager 504, the receiver 510, the transmitter 512, or various combinations or components thereof may be implemented in code (e.g., as communications management software or firmware) executed by the processor 506. If implemented in code executed by the processor 506, the functions of the communications manager 504, the receiver 510, the transmitter 512, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 504 may be configured to perform various operations (e.g., receiving, monitoring, transmitting) using or otherwise in cooperation with the receiver 510, the transmitter 512, or both. For example, the communications manager 504 may receive information from the receiver 510, send information to the transmitter 512, or be integrated in combination with the receiver 510, the transmitter 512, or both to receive information, transmit information, or perform various other operations as described herein. Although the communications manager 504 is illustrated as a separate component, in some implementations, one or more functions described with reference to the communications manager 504 may be supported by or performed by the processor 506, the memory 508, or any combination thereof. For example, the memory 508 may store code, which may include instructions executable by the processor 506 to cause the device 502 to perform various aspects of the present disclosure as described herein, or the processor 506 and the memory 508 may be otherwise configured to perform or support such operations.

For example, the communications manager 504 may support wireless communication and/or network signaling at a device (e.g., the device 502, such as a base station) in accordance with examples as disclosed herein. The communications manager 504 and/or other device components may be configured as or otherwise support an apparatus, such as a base station and/or other network device, including a transceiver; a processor coupled to the transceiver, the processor and the transceiver configured to cause the apparatus to: transmit, to a UE, configuration information for CSI-RS indicating at least one OAM mode resource; transmit, to the UE, a report configuration for the at least one OAM mode resource; and receive, based at least in part on the report configuration, a report from the UE including OAM mode-based measurements for one or more RS of the OAM mode resource.

Additionally, the apparatus (e.g., a base station) includes any one or combination of: where the configuration information for the CSI-RS further includes at least one of a time resource, a frequency resource, a time-domain behavior, an OAM mode index, a usage type corresponding to an RS transmission, an RS reception, or combinations thereof; where the configuration information for the CSI-RS is configured such that at least some of the RS correspond to an OAM mode index; where the configuration information for the CSI-RS is configured such that at least some of the RS correspond to a different type of sequence generation method for different OAM mode resources; where the configuration information for the CSI-RS is configured such that at least some of the RS are initialized with OAM mode-specific index information for different OAM modes; where the configuration information for the CSI-RS is configured such that CDM between different per-antenna port CSI-RS is extended in an OAM mode domain; where the configuration information for the CSI-RS is configured such that an OAM mode number index is configured through RRC signaling using a bit table; where the configuration information for the CSI-RS is configured such that different antenna ports are associated with different OAM modes; where the configuration information for the CSI-RS is configured such that each CSI resource identifier is associated with at least one OAM mode; where the configuration information for the CSI-RS is configured such that CSI configurations with OAM modes are one or more of aperiodic, periodic, or semi-persistent; where the apparatus transmits the report configuration as part of RRC signaling; where the apparatus receives OAM information from the UE identifying one or more OAM modes supported by the UE, and utilizes at least one supported OAM mode for transmission to the UE.

The communications manager 504 and/or other device components may be configured as or otherwise support a means for wireless communication and/or network signaling at a base station and/or other network device, including transmitting, to a UE, configuration information for CSI-RS indicating at least one OAM mode resource; transmitting, to the UE, a report configuration for the at least one OAM mode resource; and receiving, based at least in part on the report configuration, a report from the UE including OAM mode-based measurements for one or more RS of the OAM mode resource.

Additionally, wireless communication at the base station and/or other network device includes any one or combination of: where the configuration information for the CSI-RS further includes at least one of a time resource, a frequency resource, a time-domain behavior, an OAM mode index, a usage type corresponding to an RS transmission, an RS reception, or combinations thereof; where the configuration information for the CSI-RS is configured such that at least some of the RS correspond to an OAM mode index; where the configuration information for the CSI-RS is configured such that at least some of the RS correspond to a different type of sequence generation method for different OAM mode resources; where the configuration information for the CSI-RS is configured such that at least some of the RS are initialized with OAM mode-specific index information for different OAM modes.

Additionally, wireless communication at the base station and/or other network device includes any one or combination of: where the configuration information for the CSI-RS is configured such that CDM between different per-antenna port CSI-RS is extended in an OAM mode domain; where the configuration information for the CSI-RS is configured such that an OAM mode number index is configured through RRC signalling using a bit table; where the configuration information for the CSI-RS is configured such that different antenna ports are associated with different OAM modes; where the configuration information for the CSI-RS is configured such that each CSI resource identifier is associated with at least one OAM mode; where the configuration information for the CSI-RS is configured such that CSI configurations with OAM modes are one or more of aperiodic, periodic, or semi-persistent; further including transmitting the report configuration as part of RRC signaling; further including receiving OAM information from the UE identifying one or more OAM modes supported by the UE, and utilizing at least one supported OAM mode for transmission to the UE.

The processor 506 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 506 may be configured to operate a memory array using a memory controller. In some other implementations, a memory controller may be integrated into the processor 506. The processor 506 may be configured to execute computer-readable instructions stored in a memory (e.g., the memory 508) to cause the device 502 to perform various functions of the present disclosure.

The memory 508 may include random access memory (RAM) and read-only memory (ROM). The memory 508 may store computer-readable, computer-executable code including instructions that, when executed by the processor 506 cause the device 502 to perform various functions described herein. The code may be stored in a non-transitory computer-readable medium such as system memory or another type of memory. In some implementations, the code may not be directly executable by the processor 506 but may cause a computer (e.g., when compiled and executed) to perform functions described herein. In some implementations, the memory 508 may include, among other things, a basic I/O system (BIOS) which may control basic hardware or software operation such as the interaction with peripheral components or devices.

The I/O controller 514 may manage input and output signals for the device 502. The I/O controller 514 may also manage peripherals not integrated into the device 502. In some implementations, the I/O controller 514 may represent a physical connection or port to an external peripheral. In some implementations, the I/O controller 514 may utilize an operating system such as iOS®, ANDROID®, MS-DOS®, MS-WINDOWS®, OS/2®, UNIX®, LINUX®, or another known operating system. In some implementations, the I/O controller 514 may be implemented as part of a processor, such as the processor 506. In some implementations, a user may interact with the device 502 via the I/O controller 514 or via hardware components controlled by the I/O controller 514.

In some implementations, the device 502 may include a single antenna 516. However, in some other implementations, the device 502 may have more than one antenna 516, which may be capable of concurrently transmitting or receiving multiple wireless transmissions. The receiver 510 and the transmitter 512 may communicate bi-directionally, via the one or more antennas 516, wired, or wireless links as described herein. For example, the receiver 510 and the transmitter 512 may represent a wireless transceiver and may communicate bi-directionally with another wireless transceiver. The transceiver may also include a modem to modulate the packets, to provide the modulated packets to one or more antennas 516 for transmission, and to demodulate packets received from the one or more antennas 516.

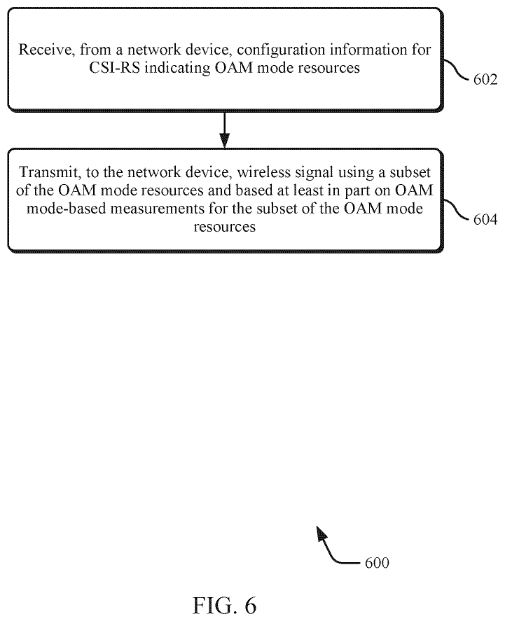

FIG. 6 illustrates a flowchart of a method 600 that supports multiple mode OAM in accordance with aspects of the present disclosure. The operations of the method 600 may be implemented and performed by a device or its components, such as a UE 104 as described with reference to FIGS. 1 through 4. In some implementations, the device may execute a set of instructions to control the function elements of the device to perform the described functions. Additionally, or alternatively, the device may perform aspects of the described functions using special-purpose hardware.

At 602, the method may include receiving, from a network device, configuration information for CSI-RS indicating OAM mode resources. The operations of 602 may be performed in accordance with examples as described herein. In some implementations, aspects of the operations of 602 may be performed by a device as described with reference to FIG. 1.

At 604, the method may include transmitting, to the network device, wireless signal using a subset of the OAM mode resources and based at least in part on OAM mode-based measurements for the subset of the OAM mode resources. The operations of 604 may be performed in accordance with examples as described herein. In some implementations, aspects of the operations of 604 may be performed by a device as described with reference to FIG. 1.

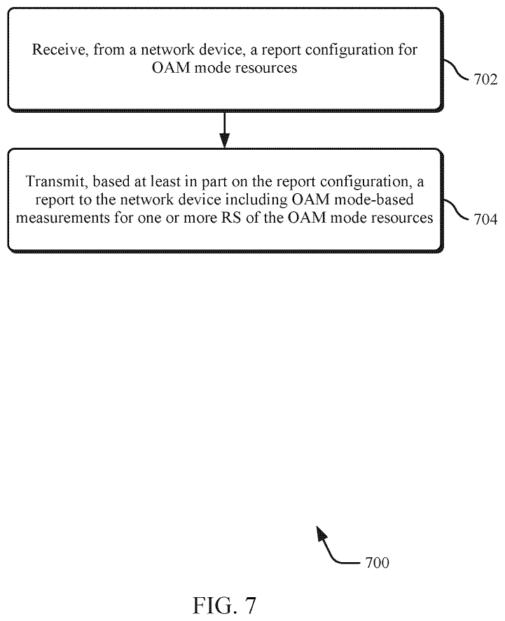

FIG. 7 illustrates a flowchart of a method 700 that supports multiple mode OAM in accordance with aspects of the present disclosure. The operations of the method 700 may be implemented and performed by a device or its components, such as a UE 104 as described with reference to FIGS. 1 through 4. In some implementations, the device may execute a set of instructions to control the function elements of the device to perform the described functions. Additionally, or alternatively, the device may perform aspects of the described functions using special-purpose hardware.

At 702, the method may include receiving, from a network device, a report configuration for OAM mode resources. The operations of 702 may be performed in accordance with examples as described herein. In some implementations, aspects of the operations of 702 may be performed by a device as described with reference to FIG. 1.

At 704, the method may include transmitting, based at least in part on the report configuration, a report to the network device including OAM mode-based measurements for one or more RS of the OAM mode resources. The operations of 704 may be performed in accordance with examples as described herein. In some implementations, aspects of the operations of 704 may be performed by a device as described with reference to FIG. 1.

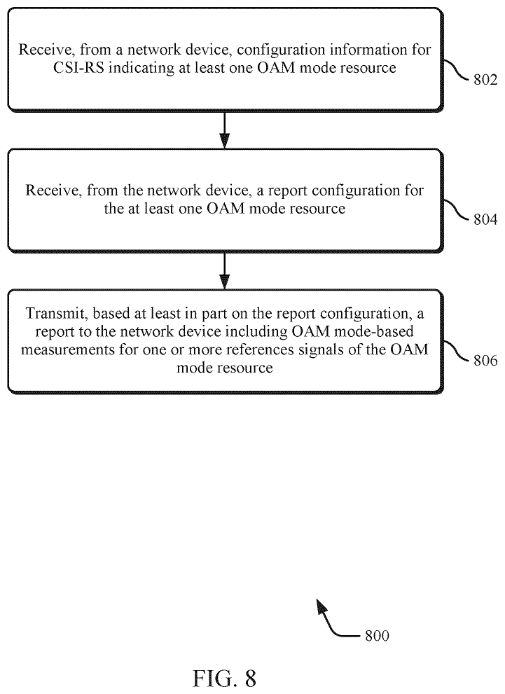

FIG. 8 illustrates a flowchart of a method 800 that supports multiple mode OAM in accordance with aspects of the present disclosure. The operations of the method 800 may be implemented and performed by a device or its components, such as a UE 104 as described with reference to FIGS. 1 through 4. In some implementations, the device may execute a set of instructions to control the function elements of the device to perform the described functions. Additionally, or alternatively, the device may perform aspects of the described functions using special-purpose hardware.

At 802, the method may include receiving, from a network device, configuration information for CSI-RS indicating at least one OAM mode resource. The operations of 802 may be performed in accordance with examples as described herein. In some implementations, aspects of the operations of 802 may be performed by a device as described with reference to FIG. 1.

At 804, the method may include receiving, from the network device, a report configuration for the at least one OAM mode resource. The operations of 804 may be performed in accordance with examples as described herein. In some implementations, aspects of the operations of 804 may be performed by a device as described with reference to FIG. 1.

At 806, the method may include transmitting, based at least in part on the report configuration, a report to the network device including OAM mode-based measurements for one or more references signals of the OAM mode resource. The operations of 806 may be performed in accordance with examples as described herein. In some implementations, aspects of the operations of 806 may be performed by a device as described with reference to FIG. 1.

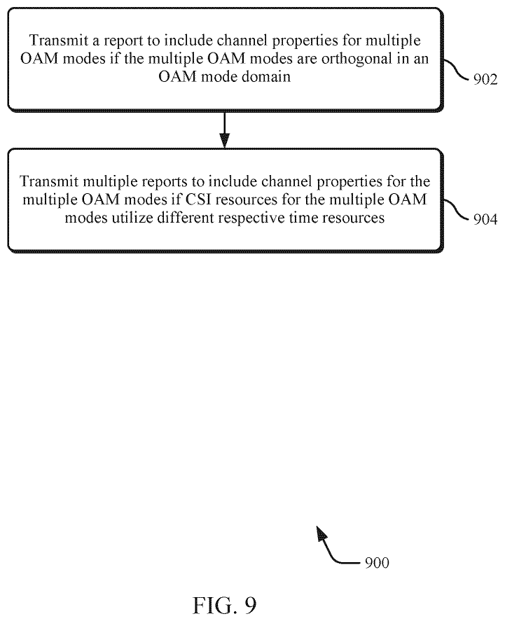

FIG. 9 illustrates a flowchart of a method 900 that supports multiple mode OAM in accordance with aspects of the present disclosure. The operations of the method 900 may be implemented and performed by a device or its components, such as a UE 104 as described with reference to FIGS. 1 through 4. In some implementations, the device may execute a set of instructions to control the function elements of the device to perform the described functions. Additionally, or alternatively, the device may perform aspects of the described functions using special-purpose hardware.

At 902, the method may include transmitting a report to include channel properties for multiple OAM modes if the multiple OAM modes are orthogonal in an OAM mode domain. The operations of 902 may be performed in accordance with examples as described herein. In some implementations, aspects of the operations of 902 may be performed by a device as described with reference to FIG. 1.

At 904, the method may include transmitting multiple reports to include channel properties for the multiple OAM modes if CSI resources for the multiple OAM modes utilize different respective time resources. The operations of 904 may be performed in accordance with examples as described herein. In some implementations, aspects of the operations of 904 may be performed by a device as described with reference to FIG. 1.

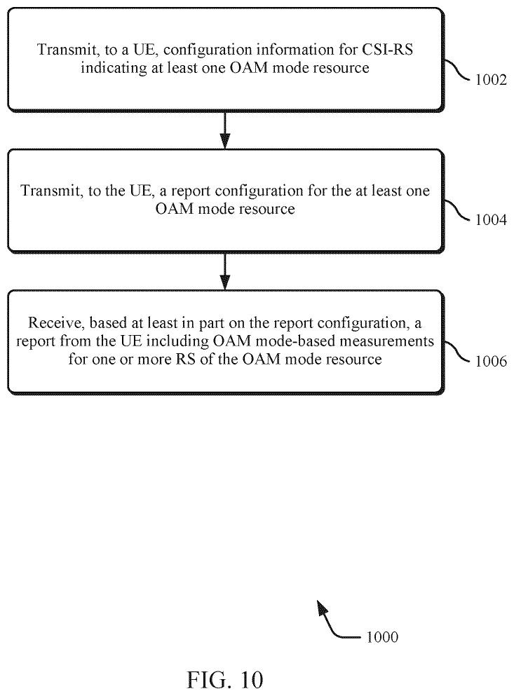

FIG. 10 illustrates a flowchart of a method 1000 that supports multiple mode OAM in accordance with aspects of the present disclosure. The operations of the method 1000 may be implemented and performed by a device or its components, such as a base station and/or other network device as described with reference to FIGS. 1 through 5. In some implementations, the device may execute a set of instructions to control the function elements of the device to perform the described functions. Additionally, or alternatively, the device may perform aspects of the described functions using special-purpose hardware.

At 1002, the method may include transmitting, to a UE, configuration information for CSI-RS indicating at least one OAM mode resource. The operations of 1002 may be performed in accordance with examples as described herein. In some implementations, aspects of the operations of 1002 may be performed by a device as described with reference to FIG. 1.

At 1004, the method may include transmitting, to the UE, a report configuration for the at least one OAM mode resource. The operations of 1004 may be performed in accordance with examples as described herein. In some implementations, aspects of the operations of 1004 may be performed by a device as described with reference to FIG. 1.

At 1006, the method may include receiving, based at least in part on the report configuration, a report from the UE including OAM mode-based measurements for one or more RS of the OAM mode resource. The operations of 1006 may be performed in accordance with examples as described herein. In some implementations, aspects of the operations of 1006 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined. The order in which the methods are described is not intended to be construed as a limitation, and any number or combination of the described method operations may be performed in any order to perform a method, or an alternate method.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C, or AB or AC or BC, or ABC (i.e., A and B and C). Similarly, a list of one or more of A, B, or C means A or B or C, or AB or AC or BC, or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory, and
at least one processor coupled with the at least one memory and configured to cause the UE to:
receive configuration information for channel state information (CSI) reference signals (RS) indicating orbital angular momentum (OAM) mode resources; and
transmit wireless signal using a subset of the OAM mode resources and based at least in part on OAM mode-based measurements for the subset of the OAM mode resources.

2. The UE of claim 1, wherein the configuration information for the CSI-RS further comprises at least one of a time resource, a frequency resource, a time-domain behavior, an OAM mode index, a usage type corresponding to an RS transmission, a reference signal reception, or combinations thereof.

3. The UE of claim 1, wherein the configuration information for the CSI-RS is configured such that at least some of the RS correspond to an OAM mode index.

4. The UE of claim 1, wherein the configuration information for the CSI-RS is configured such that at least some of the RS correspond to a different type of sequence generation method for each of the OAM mode resources.

5. The UE of claim 1, wherein the configuration information for the CSI-RS is configured such that at least some of the RS are initialized with OAM mode-specific index information for different OAM modes.

6. The UE of claim 1, wherein the configuration information for the CSI-RS is configured such that code division multiplexing (CDM) between different per-antenna port CSI-RS is extended in an OAM mode domain.

7. The UE of claim 1, wherein the configuration information for the CSI-RS is configured such that an OAM mode number index is configured through radio resource control (RRC) signalling using a bit table.

8. The UE of claim 1, wherein the configuration information for the CSI-RS is configured such that different antenna ports are associated with different OAM modes.

9. The UE of claim 1, wherein the configuration information for the CSI-RS is configured to include CSI resource identifiers, and wherein each CSI resource identifier is associated with at least one OAM mode.

10. The UE of claim 1, wherein the configuration information for the CSI-RS is configured such that CSI configurations with OAM modes are one or more of aperiodic, periodic, or semi-persistent.

11. The UE of claim 1, wherein the at least one processor is configured to cause the UE to:
receive a report configuration for the OAM mode resources; and
transmit, based at least in part on the report configuration, a report including OAM mode-based measurements for one or more RS of the OAM mode resources.

12. The UE of claim 11, wherein a report for each RS of a plurality of RS indicates at least an OAM mode based on OAM mode-based channel measurements.

13. The UE of claim 12, wherein the at least one processor is configured to cause the UE to transmit multiple reports, and wherein each report is specific to an individual OAM mode.

14. A user equipment (UE) for wireless communication, comprising:
at least one memory, and
at least one processor coupled with the at least one memory and configured to cause the UE to:
receive configuration information for channel state information (CSI) reference signals (RS) indicating at least one orbital angular momentum (OAM) mode resource;
receive a report configuration for the at least one OAM mode resource; and
transmit, based at least in part on the report configuration, a report including OAM mode-based measurements for one or more references signals of the OAM mode resource.

15. The UE of claim 14, wherein the at least one processor is configured to cause the UE to transmit multiple reports, and wherein each report is specific to an individual OAM mode.

16. An apparatus for wireless communication, comprising:
at least one memory; and
at least one processor coupled with the at least one memory and configured to cause the apparatus to:
transmit configuration information for channel state information (CSI) reference signals (RS) indicating at least one orbital angular momentum (OAM) mode resource;
transmit a report configuration for the at least one OAM mode resource; and
receive, based at least in part on the report configuration, a report including OAM mode-based measurements for one or more RS of the OAM mode resource.

17. The apparatus of claim 16, wherein the configuration information for the CSI-RS further comprises at least one of a time resource, a frequency resource, a time-domain behavior, an OAM mode index, a usage type corresponding to an RS transmission, an RS reception, or combinations thereof.

18. The apparatus of claim 16, wherein the configuration information for the CSI-RS is configured such that at least some of the RS correspond to an OAM mode index.

19. The apparatus of claim 16, wherein the configuration information for the CSI-RS is configured such that one or more of:
at least some of the RS correspond to a different type of sequence generation method for different OAM mode resources; or
at least some of the RS are initialized with OAM mode-specific index information for different OAM modes.

20. (canceled)

21. A processor for wireless communication, comprising:
at least one controller coupled with at least one memory and configured to cause the processor to:
receive configuration information for channel state information (CSI) reference signals (RS) indicating orbital angular momentum (OAM) mode resources; and
transmit wireless signal using a subset of the OAM mode resources and based at least in part on OAM mode-based measurements for the subset of the OAM mode resources.
